(19) United States
(12) Patent Application Publication
(10) Pub. No.: US 2012/0189973 A1
(43) Pub. Date: Jul. 26, 2012

(54) Catch Device for Catching Particles in Oral Fluid Originating in the Mouth of a Patient in Dental Treatments

(76) Inventor: Thomas Schwenk, Nuremberg (DE)

(21) Appl. No.: 13/383,758

(22) PCT Filed: Jul. 7, 2010
(86) PCT No.: PCT/EP2010/059727

§ 371 Date: Mar. 29, 2012

(30) Foreign Application Priority Data
Jul. 20, 2009 (DE) 10 2009 034 143.9

(51) Int. Cl. A61C 17/06; A61C 19/04; A61C 17/00; A61C 17/12

(52) U.S. Cl. 433/27; 433/92; 433/215

(57) ABSTRACT

A collecting arrangement for collecting particles from oral fluid from the mouth of a patient during dental treatments, has a) a first particle separating device for separating particles from the oral fluid, wherein the first particle separating device is arrangeable in a flow path of the oral fluid, and b) a second particle separating device for separating particles from the oral fluid, wherein the second particle separating device is arrangeable in a flow path of the oral fluid, c) wherein the first particle separating device is activated or operative when particles not containing noble metal (and/or contain mercury) are present in the oral fluid and d) the second particle separating device is active or operative when particles that contain noble metal are present in the oral fluid and are deactivated or inoperative when particles that do not contain noble metal and/or contain mercury are present in the oral fluid.

The invention relates to a collecting arrangement for collecting particles from (or: in) oral fluid originating from the mouth a patient during dental treatments, and also to a suction arrangement for dental treatments and to a method for the suction-extraction of oral fluid originating from the mouth of a patient during a dental treatment.

Suction arrangements for dental treatments serve for the suction-extraction of suction-extraction material or oral fluid from the mouth of the patient, wherein the suction-extraction material or the oral fluid typically comprises saliva, supplied rinsing fluid or rinsing water, original tooth material or else tooth replacement material or tooth filling material, which is in the form of solid particles and is milled out, drilled out or ground out by the dentist during the treatment. To this end, the suction arrangements comprise a suction mouthpiece to be introduced into the mouth of the patient, said suction mouthpiece being known in a variety of embodiments, and a delivery pump, which is connected via a delivery tube to the mouthpiece, in order to generate the necessary negative pressure.

During suction-extraction, no particles that have been milled or drilled out of the teeth and contain amalgam or mercury may pass into the wastewater system. For this reason, the suction arrangements in dental practices are provided not only with coarse screens for screening out relatively large contaminants from the suction-extraction material, but also with filter devices or separation devices as amalgam-particle collecting arrangements, which separate the amalgam particles, which are often also relatively small, from the suction-extraction material so that the suction-extraction material purified in this way can then be passed into the wastewater.

In filter devices, the particles remain caught in a filter which has a correspondingly fine mesh, while in a separation device the particles are separated from the oral fluid or saliva on account of physical forces, in particular on account of gravity in gravity separators, in which the particles settle downwardly, or on account of centrifugal forces in centrifugal separators.

U.S. Pat. No. 4,332,560 A discloses a dental suction apparatus having a particle collector. This particle collector, which is in the form of a separation container, is used only in the trimming of amalgam fillings, which takes place by scraping off and shaping the still soft mass, and to this end is arranged between a suction mouthpiece and a suction pump in order to collect the relatively clean amalgam particle waste produced during trimming. However, during drilling, when blood and tooth or bone particles are produced, the particle collector is removed from the suction apparatus or bypassed by means of a rotary disk and the suction-extraction material that is extracted by suction during drilling is passed directly to the pump and a sump located there without passing into or through the particle collector. As a result, the amalgam waste, some of which contains silver, can be collected in the separation container without significant contamination and can be recycled separately. However, if the dentist accidentally forgets, during trimming, to arrange or connect the particle collector between the mouthpiece and the suction pump or encounters old amalgam fillings during drilling, in this known suction apparatus, the amalgam passes into the wastewater via the drain in the dental practice.

In dental treatments, in particular the milling or drilling or grinding out of dental fillings, not only do amalgam particles accumulate, but also particles consisting of noble metals that are used in dentistry or dental technology, in particular gold and/or silver and/or platinum, or corresponding noble metal alloys or compounds.

These particles that contain noble metal are separated from the saliva in the dental practice together with the particles that contain mercury by way of the filter device or separation device and the material that is separated from the saliva and contains both particles that contain mercury and also mercury-free particles that contain noble metal is delivered by the dentist to a disposal company. The disposal company separates the separated material in industrial separating plants into the various components that contain mercury and the mercury-free components that contain noble metal, these components then being reused or, if necessary, disposed of. This method involves a high degree of outlay.

DE 83 14 829 U1 discloses a gravity separator for suction appliances for dentists. This gravity separator comprises at least two separator containers which are arranged in succession in the suction direction, are each provided in a detachable manner on head pieces and into which in each case one suction tube is inserted through the head piece, wherein one head piece or suction tube is connected to a suction connection that leads to the suction mouthpiece and the other head piece or suction tube is connected to the suction pump and the two separator containers are connected to one another in series. The saliva extracted by suction is guided in succession through the separator containers, with heavier particles settling at the bottom. DE 83 14 829 U1 states that not only particles such as amalgam particles or gold dust or other secretions can be reliably separated in a continuous process, but also that the various particles are at the same time sorted in a filter-free arrangement, with the various particles primarily being differentiated by their specific weight and also by their size.

However, since the specific weights of amalgam particles and gold particles are approximately in the same order of magnitude and neither the amalgam particles nor the noble metal particles have reliably characteristic sizes, reliable separation of the amalgam particles from the noble metal particles is not possible with this known separation arrangement, but rather amalgam particles will be found in both containers.

It is the object of the invention to provide a collecting arrangement for collecting particles from oral fluid originating from the mouth of a patient during dental treatments and also a suction arrangement and a suction method for dental treatments, said arrangements and method enabling reliable separation of particles that do not contain noble metal and/or contain mercury, such as amalgam particles, on the one hand, from particles that contain noble metal, on the other.

This object is achieved by the features of claim 1 with regard to the collecting arrangement, of claim 22 with regard to the suction arrangement and of claim 31 with regard to the method. Further features, advantages and particular embodiments are the subject matter of the dependent claims.

The collecting arrangement as per claim 1 is suitable and intended for collecting particles from or in oral fluid originating from the mouth of a patient during dental treatments and comprises a first particle separating device and a second particle separating device, which are both provided to separate particles from the oral fluid and are arranged or arrangeable in a flow path of the oral fluid. The first particle separating device is activated or operative when particles that do not contain noble metal and/or contain mercury are present in the oral fluid and the second particle separating device is active or operative when particles that contain noble metal are present in the oral fluid but is deactivated or inoperative when particles that do not contain noble metal and/or contain mercury are present in the oral fluid.

A suction arrangement as per claim 22 is provided for dental treatments for the suction-extraction of oral fluid originating from the mouth of a patient and comprises

a) at least one suction mouthpiece, which is introduced or introducible into the mouth of the patient in order to extract the oral fluid from the mouth by suction,

and/or

b) at least one collecting basin (or: sink, cuspidor) for collecting oral fluid,

c) at least one delivery device (or: delivery pump), which is connected or connectable via at least one flow path to at least one suction mouthpiece or to the collecting basin, in order to generate a negative pressure at the suction mouthpiece or collecting basin in order to extract the oral fluid by suction, and

d) a collecting arrangement according to the invention for collecting particles from the oral fluid extracted by suction.

The method as per claim 31 is suitable and intended for the suction-extraction of oral fluid originating from the mouth of a patient during a dental treatment and comprises the method steps of:

a) introducing at least one suction mouthpiece into the mouth of the patient,

and/or

b) providing at least one collecting basin for collecting oral fluid,

c) generating a negative pressure at the suction mouthpiece and/or collecting basin in order to extract the oral fluid by suction by means of at least one delivery device, which is connected or connectable via at least one flow path to at least one suction mouthpiece or the collecting basin,

d) activating or switching into the operative state a first particle separating device, which is arranged or arrangeable in the flow path of the oral fluid, in particular in the flow path between at least one suction mouthpiece or the collecting basin and at least one delivery device, when the oral fluid contains particles that contain mercury, and which thus separates the particles that contain mercury from the oral fluid,

e) activating or switching into the operative state a second particle separating device, which is arranged in the flow path of the oral fluid, in particular in the flow path between at least one suction mouthpiece or the collecting basin and at least one delivery device,
or arranging or introducing a second particle separating device into the flow path of the oral fluid, in particular into the flow path between at least one suction mouthpiece or the collecting basin and at least one delivery device,
when the oral fluid contains particles that contain noble metal,
as a result of which or wherein the second particle separating device separates the particles that contain noble metal from the oral fluid, and

f) deactivating or switching the second particle separating device into the inoperative state, or removing the second particle separating device from the flow path, when the oral fluid contains particles that contain mercury, so that the second particle separating device is not contaminated by particles that contain mercury.

The term “patient” should be understood as meaning male and female patients. The expression “oral fluid originating from the mouth of a patient” should be understood as meaning oral fluid which is (still) in the mouth and also oral fluid that has already been spat out, for example into a collecting basin. The oral fluid generally comprises saliva and/or rinsing and/or cooling fluid supplied during the treatment, with additions of particles detached from the teeth or tooth replacement during treatment and possibly blood.

The invention is based in particular on the consideration of providing, in dental collecting arrangements or suction arrangements or suction methods, in addition to an initially provided first particle separating device, which is arranged or arrangeable in the flow path (or: in the suction direction, in the delivery path or in the delivery line) of the suction-extraction material or the oral fluid, in particular between at least one suction mouthpiece or collecting basin and at least one delivery device, an additional second particle separating device in the flow path of the suction-extraction material, in particular between at least one suction mouthpiece or the collecting basin and at least one delivery device, wherein the first particle separating device is active or operative during the extraction by suction of suction-extraction material which contains particles that do not contain noble metal and/or contain mercury, and the second particle separating device is active or operative during the extraction by suction of suction-extraction material which contains particles that contain noble metal, and preferably do not contain mercury, and is inactive or inoperative during the extraction by suction of suction-extraction material which contains particles that do not contain noble metal and/or contain mercury.

According to a preferred embodiment of the invention, there is provided a switchover device, wherein the switchover device in a first switching state switches the second particle separating device into the flow path of the oral fluid (or: in the suction direction), in particular between the suction mouthpiece or the collecting basin and the delivery device, or arranges it therein and in a second switching state switches the second particle separating device out of the flow path of the suction-extraction material, in particular between the suction mouthpiece or the collecting basin and the delivery device, or removes it therefrom.

The switchover device is preferably actuable by the dentist at a time specifiable by the latter or can be brought into one of the switching states or else can be switched over between the switching states, for example at a time at which the dentist knows that, up to a further time, he will be milling or drilling tooth replacement particles that contain noble metal, but do not contain mercury, out of the mouth. To this end, there is provided preferably a switch, in particular a pressure switch, rotary switch or pushbutton or a two-way valve or a valve slide or the like, or some other operating device or input device, for example having voice-controlled input, for the operator or dentist to switch over the switchover device.

However, it is also possible for the switchover device to be switched over in a sensor-controlled manner by means of sensors which sense the chemical composition or the presence of noble metal or mercury in the particle residues in the suction-extraction material.

In a first main variant of the invention, the first particle separating device and the second particle separating device are connected in parallel in terms of flow and/or are arranged in each case between two branching points in two partial flow paths or flow branches or flow ducts.

In a preferred embodiment, the switchover device is arranged or provided at a branching point located upstream or towards the suction mouthpiece, or upstream or before the parallel connection towards the suction mouthpiece. In this variant, the switchover device switches the flow connection of the suction mouthpiece and the delivery device back and forth between the two branches of the parallel connection and thus between the two particle separating devices, in other words directs the suction-extraction material to the at least one delivery device either via the first particle separating device or via the second particle separating device.

In a further embodiment of the invention, the suction arrangement has a branching device having an inlet, a first outlet and a second outlet, wherein the branching device is coupled, in a switchable manner optionally between the first outlet and the second outlet, to the mouthpiece via the inlet, to the first particle separating device via the first outlet and to the second particle separating device via the second outlet. Sorting is enabled by the setting of the branching device.

In a first switching state of the switchover device or branching device, the flow branch having the first particle separating device is connected between the suction mouthpiece and the delivery device and the first particle separating device is thus located in the flow path and acts in a separating manner or is active in order to separate particles, in particular the particles that do not contain noble metal and/or contain mercury, from the suction-extraction material. By contrast, the second particle separating device is inactive or inoperative. In the second switching state of the switchover device, by contrast, the partial flow path or flow branch having the second particle separating device is connected between the suction mouthpiece and the delivery device and the second particle separating device is thus located in the flow of the suction-extraction material and acts in a separating manner or is active in order to separate particles that contain noble metal and do not contain mercury from the suction-extraction material. By contrast, the first particle separating device is inactive or inoperative. Thus, in the first main variant in each case only one of the two particle separating devices is flowed through by the suction-extraction material, depending on the switching state of the switchover device.

In a second main variant of the invention, the first particle separating device and the second particle separating device are connected or arranged in series or in succession between the suction mouthpiece and the delivery device, preferably such that the second particle separating device is connected or arranged upstream of the first particle separating device or in front of the latter towards the suction mouthpiece.

A bypass line (or: a bypass branch) is now provided preferably at the second particle separating device and, when it is activated, guides the suction-extraction material past the second particle separating device, i.e. is connected in parallel therewith, generally between a branching point located upstream towards the mouthpiece in the flow path and a further branching point located between the second particle separating device and the first particle separating device.

In the second main variant, the switchover device is arranged preferably at the upstream branching point of the bypass line and second particle separating device or of a feed line leading to the second particle separating device. In the first switching state of the switchover device, the bypass or the bypass line is connected into the flow path between the suction mouthpiece and the first particle separating device, but the second particle separating device is not. Consequently, the second particle separating device is inactive or inoperative and the first particle separating device is located alone in the flow and is operative or active in order to separate particles, in particular particles that contain mercury, from the suction-extraction material. By contrast, in the second switching state of the switchover device, the second particle separating device is connected between the suction mouthpiece and the delivery device, but the bypass is not, as a result of which the second particle separating device is located in the flow path and is operative or active in order to separate particles that contain noble metal, in particular particles that do not contain mercury, from the suction-extraction material. After flowing through the second particle separating device, the suction-extraction material also flows through the first particle separating device, which, if necessary, separates out further, for example, finer, particles.

Thus, in the second main variant, either both particle separating devices are arranged in succession in the flow path of the suction-extraction material and are consequently both flowed through by the suction-extraction material or only the first particle separating device is arranged therein, depending on the switching state of the switchover device.

In a third main variant, two suction mouthpieces are provided, wherein the first particle separating device is assigned to a first mouthpiece and the second particle separating device is assigned to the second mouthpiece. In other words, one mouthpiece can be connected upstream of the first particle separating device and a further mouthpiece can be connected upstream of the second particle separating device. In this case, sorting is enabled by the selection of the mouthpiece. The dentist will thus determine, by selection of the mouthpiece, which of the two particle separating devices he uses or activates and thus which type of particles will be separated out of the suction-extraction material.

According to a fourth main variant, the second particle separating device is arranged by the dentist in the mouth of the patient, in particular in the vicinity of the tooth being treated and/or in front of the suction opening of the mouthpiece, or in the mouthpiece itself. In this case, primarily filters or woven filter fabrics or else carriers having a surface to which the particles adhere are appropriate.

According to a fifth main variant, which can also be combined with other embodiments, the second particle separating device is insertable or introducible manually or else automatically into the flow path of the oral fluid and also removable or replaceable again, in particular exchangeable for an empty second particle separating device, if it is filled with noble metal particles.

To this end, in particular a holding device for releasably holding the second particle separating device in the flow path is provided. The second particle separating device is inserted or arranged in the holding device when particles that contain noble metal are present in the oral fluid and is removed from the holding device when particles that do not contain noble metal and/or contain mercury are present in the oral fluid, with appropriate sealing measures being taken in order that the oral fluid does not emerge at the holding device. Furthermore, the second particle separating device can be installed in the flow path as an entire component or together with a provided holding device or can be disassembled or removed from the flow path.

In an advantageous embodiment, the holding device is configured for the second particle separating device itself or a component formed from the holding device and the second particle separating device is configured as or on a connection part (or: adapter), via which the suction mouthpiece is connected or connectable, in particular in a detachable manner, to a delivery line or a delivery tube. The connection part can then be removed as a whole and passed to recycling.

Alternatively, the second particle separating device can be fastened or fastenable, in particular in a detachable or exchangeable manner, also at the suction mouthpiece, in particular in front of the suction opening thereof, as an entire component or together with a provided holding device.

The assignment of the particle content in the oral fluid to one of the two particle separating devices and thus the separation of the specific particle type according to the invention is settable or selectable manually by the user or dentist, preferably via the operating device assigned to the switchover device or the manual selection of the mouthpiece used or the manual or else automatic introduction or removal of the second particle separating device. Usually, the dentist can assume that a tooth or tooth replacement does not contain both material that contains noble metal and material that does not contain noble metal, such as amalgam, at the same location. Therefore, the user or dentist can, before taking tooth replacement material out of the mouth, activate or switch on or manually attach or plug in the appropriate particle separating device, in particular the second particle separating device before treating a tooth replacement having noble metal and the first particle separating device before treating a tooth replacement having amalgam. Since in these two cases, as a rule, no further particles having a similar density or size occur, the two particle separating devices can be provided with relatively low outlay in terms of structural design. Thus, the amalgam particles can be separated easily from the noble metal particles.

Since the two particle separating devices are separated functionally by switching or connection or the manual or automatic addition or exchange or activation or deactivation, simple particle separating devices which are known per se, in particular from dental technology, can be used for the second particle separating device for separating the particles that contain noble metal. Preferably, suitable filter devices or particle separating devices such as gravity separators or centrifuges come into consideration as the second particle separating device for the particles that contain noble metal, it being possible for simple embodiments, for example filters having a relatively large mesh width which is designed only for the particles that contain noble metal, also to suffice. Furthermore, a second particle separating device having a surface to which the particles adhere can be used, in particular in the mouth, for example as a modified cofferdam. In order to separate mercury, which is necessary for the prevention of water pollution, the first particle separating device is specifically also provided, and all sufficiently reliable separating devices that are already known can be used for this purpose.

Alternatively, or in addition, at least one further particle separating device may be connected upstream and/or downstream of the first particle separating device and/or the second particle separating device. In this case, too, the at least one further particle separating device is provided, in particular for separating such particles from the suction-extraction material, said particles differing from the particles that contain amalgam or from the particles made of noble metals and/or noble metal compounds in terms of their density and/or grain size.

Finally, a control device for controlling and/or regulating the at least one delivery device can be provided. Furthermore, the control device can be provided to control and/or regulate at least one of the two particle separating devices.

Exemplary embodiments of the suction arrangement according to the invention are explained in more detail in the following text with reference to the appended drawings, in which, in each case schematically:

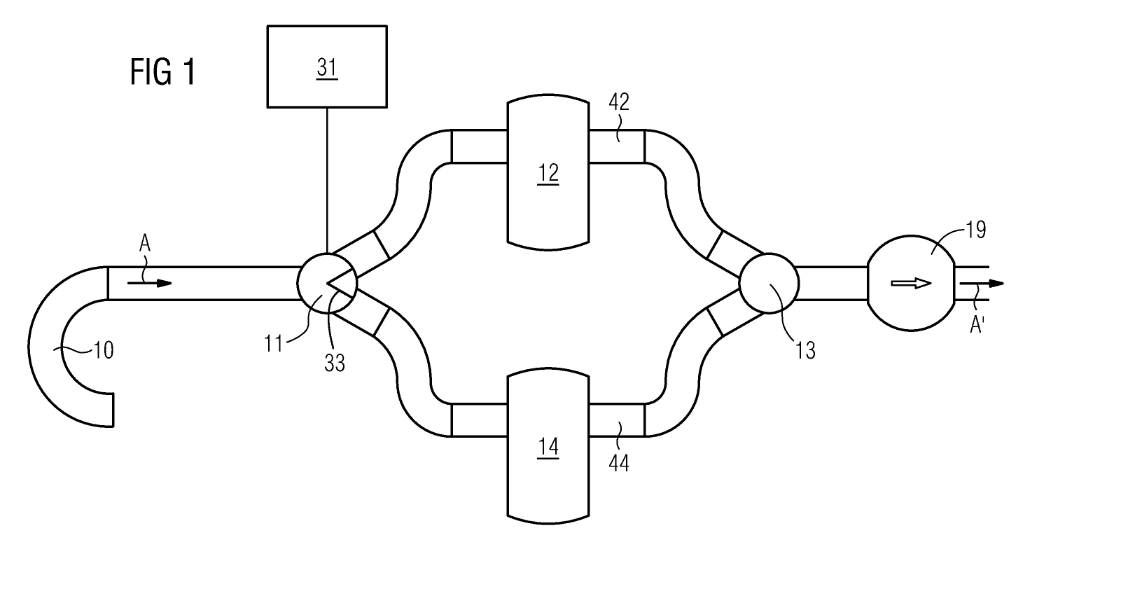

FIG. 1 shows a suction arrangement for dental treatments, having two particle separating devices that are connected in parallel and have a common mouthpiece and a common delivery device,

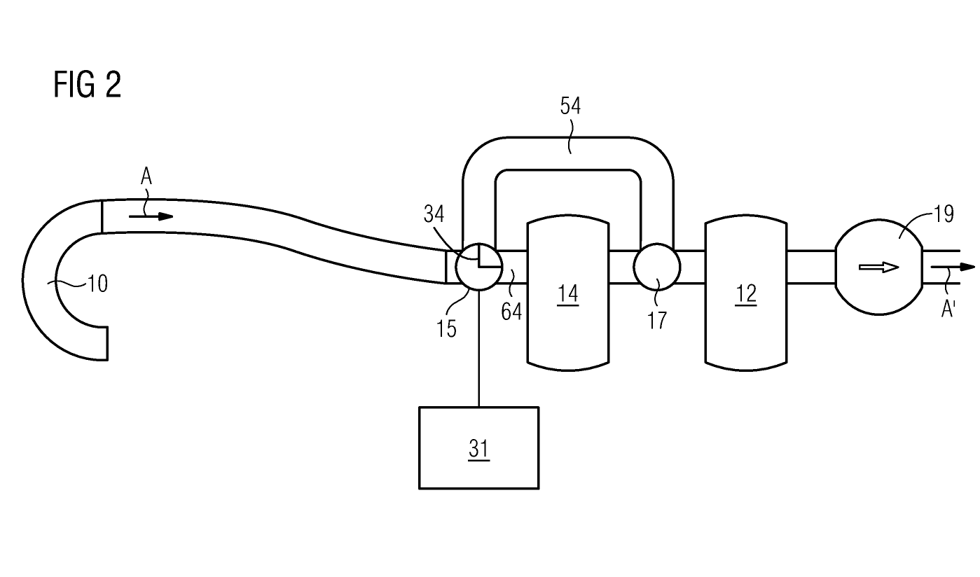

FIG. 2 shows a suction arrangement for dental treatments, having two particle separating devices that are connected or connectable in series,

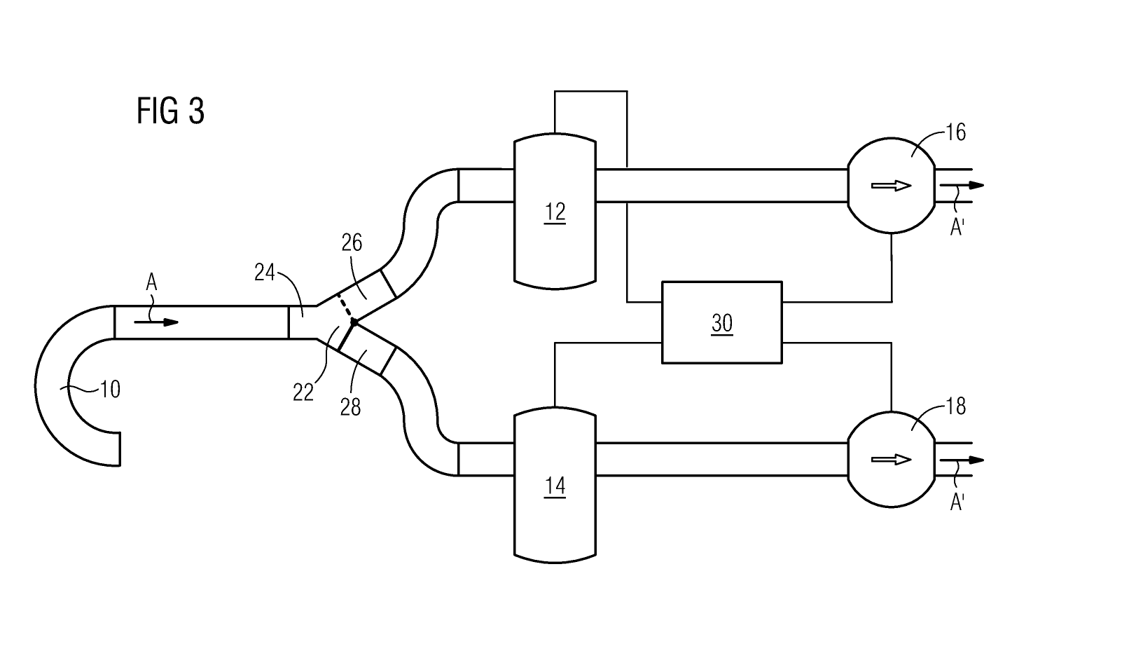

FIG. 3 shows a suction arrangement for dental treatments, having two particle separating devices that are connected in parallel and have a common mouthpiece and two delivery devices,

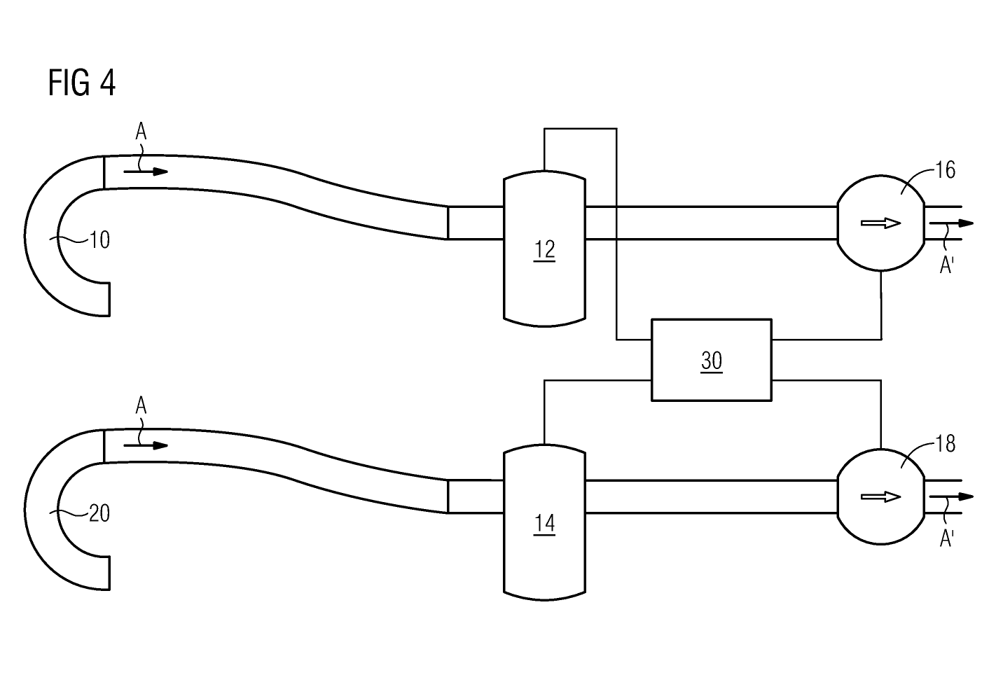

FIG. 4 shows a suction arrangement for dental treatments, having two separate particle separating devices having separate mouthpieces and delivery devices and a common control unit, and

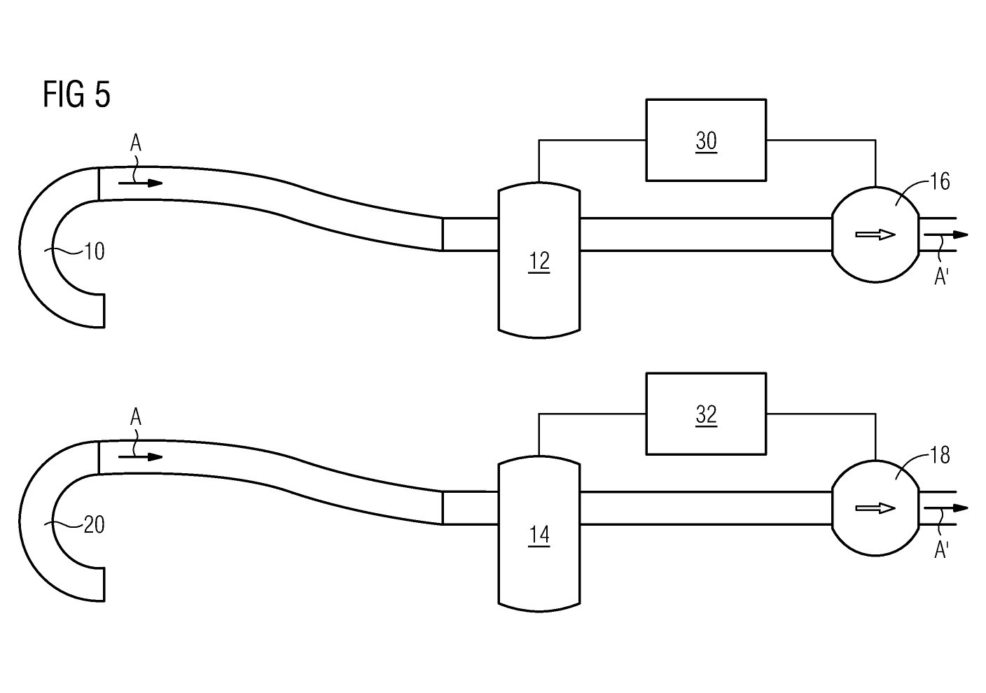

FIG. 5 shows a suction arrangement for dental treatments, having two separate particle separating devices having separate mouthpieces and delivery devices and separate control units.

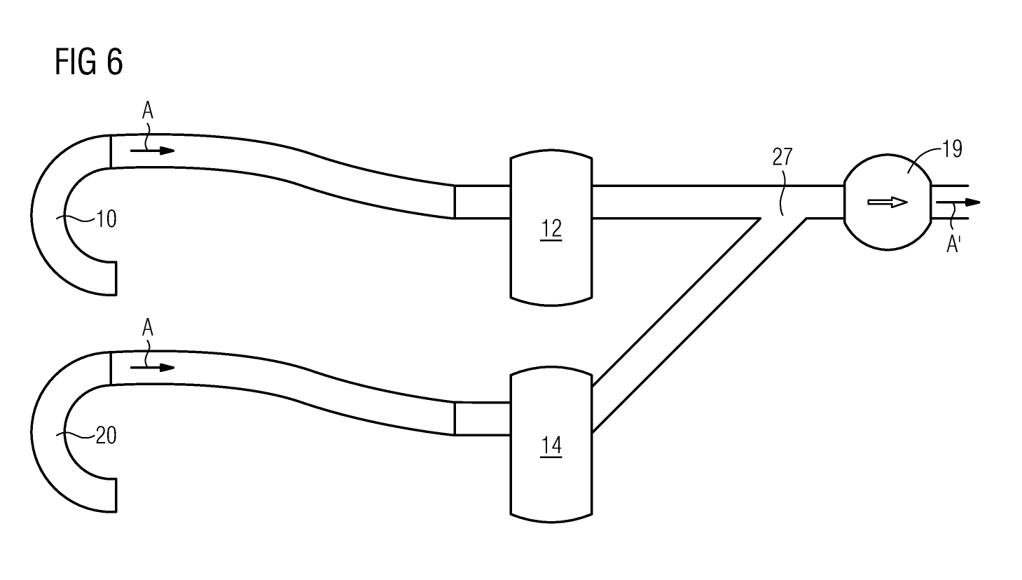

FIG. 6 shows a suction arrangement for dental treatments, having two particle separating devices that are connected in parallel and have separate mouthpieces and one delivery device,

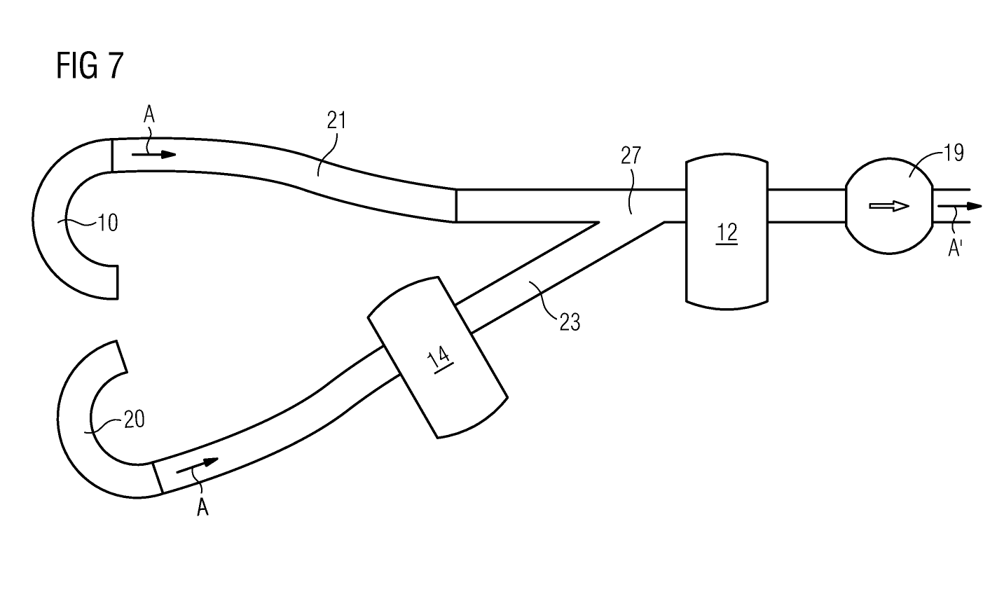

FIG. 7 shows a suction arrangement for dental treatments, having one mouthpiece having a particle separating device connected downstream and a parallel second mouthpiece and a second particle separating device and delivery device connected downstream of both mouthpieces,

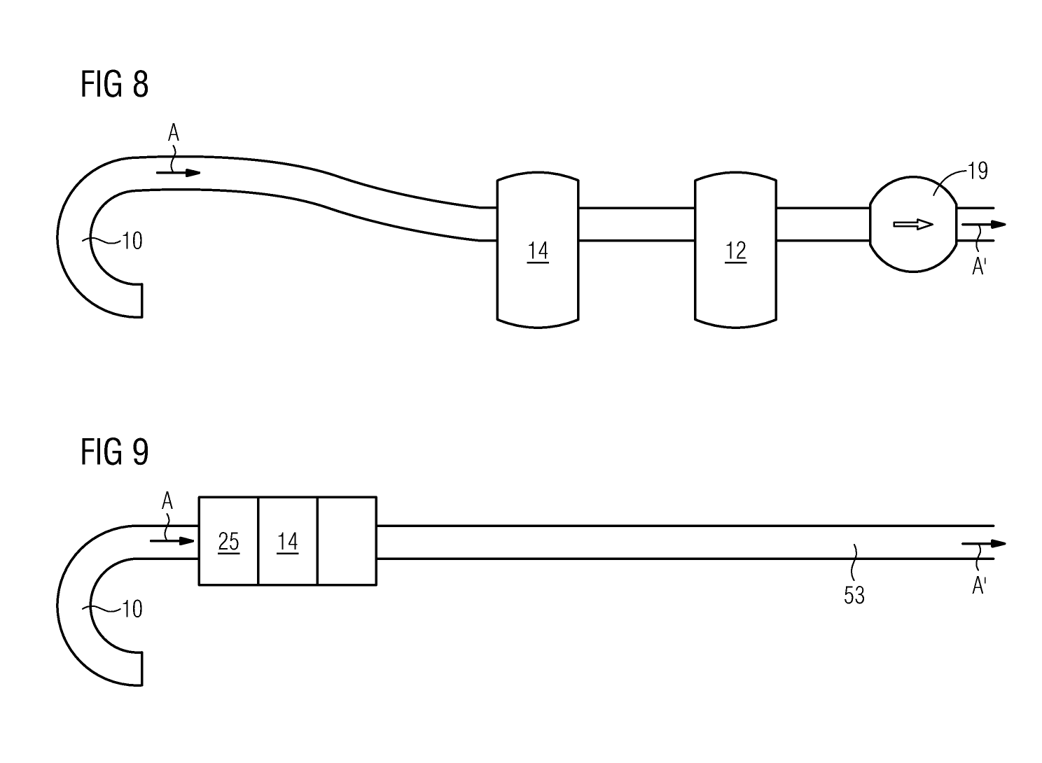

FIG. 8 shows a suction arrangement for dental treatments, having two particle separating devices that are connected in series, one of which is removable,

FIG. 9 shows a part of a suction arrangement having a particle separating device integrated in an adapter for the mouthpiece, and

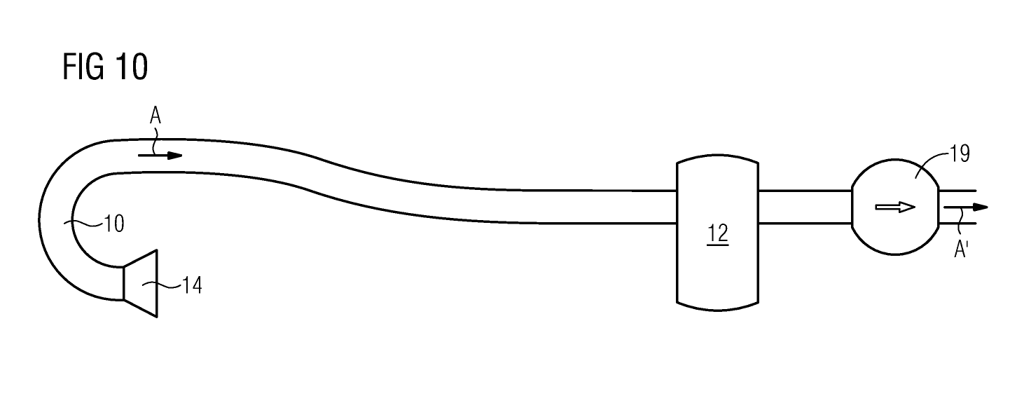

FIG. 10 shows a part of a suction arrangement, having a particle separating device arranged in front of the suction opening of the mouthpiece.

The suction arrangements according to FIGS. 1 to 10 are provided for a dental practice or dental treatment and each comprise at least one suction mouthpiece 10 or 20, called mouthpiece for short in the following text, which is inserted into the mouth of the patient in order to extract oral fluid or suction-extraction material A from the mouth by suction.

The oral fluid A generally comprises saliva and/or rinsing and/or cooling fluid supplied during the treatment, with additions of particles detached from the teeth or tooth replacement during treatment and possibly blood.

The mouthpiece 10 or 20, which is known per se, can be configured in a large variety of ways, for example as a curved tube section or tube connection stub, which can be fixed to the lower jaw or underneath the lower lip of the patient, or else in other configurations.

At the mouthpiece 10 or 20, a negative pressure for the suction-extraction of the oral fluid A in the suction or delivery direction, indicated by an arrow, is generated by means of a delivery device which is generally configured as a delivery pump and has the reference sign 19 in FIG. 1, 2, 6, 7, 8 or 10 and the reference sign 16 or 18 in FIGS. 3 to 5. The flow path or paths for the suction-extraction material is or are formed preferably with hoses or tubes.

Furthermore, the suction arrangements according to FIGS. 1 to 10 comprise a collecting arrangement, which has in each case a first particle separating device 12 for separating at least particles that contain harmful materials, in particular amalgam or mercury, from the oral fluid A and a second particle separating device 14 for separating particles that contain noble metal, in particular gold, silver or platinum, from the oral fluid A. The suction-extraction material or oral fluid freed of particles by means of the two particle separating devices 12 and 14 is designated A′ and is commonly supplied to the drain or wastewater system.

The two particle separating devices 12 and 14 can be configured in particular as separator devices, in particular gravity separators, centrifugal separators and/or sedimentation separators, or be configured as filter devices, which are suitable for separating or filtering out the corresponding particles having the corresponding particle densities or particle sizes. However, it is also possible to use electrophysical or electrochemical particle separating devices, which are based for example on ion exchange or oxidation, or else combinations of as many of said variants of particle separating devices as desired.

In particular, it is possible to use gravity separators, in which, as a result of swirling, given a sufficient residence time of the flowing medium containing the particles in a container in the gravity separator, heavy particles settle on the bottom. As centrifugal separators, use can be made in particular of centrifugal separators having a rotating drum, into which the suction-extraction material flows, and in which those particles which drop below a certain mass settle on the wall of the drum. In a sedimentation separator, the sinking behavior of the relatively heavy particles that contain amalgam and/or noble metal in a substantially horizontal flow at low speed is used.

According to the invention, the two particle separating devices 12 and 14 are connected or arranged in different connection variants between the mouthpiece 10 or 20, on one side, and the delivery device 19 or 16 or 18 on the other.

According to FIG. 1, the two particle separating devices 12 and 14 are connected in parallel with one another in the flow path of the suction-extraction material A between a first branching point 11, located upstream towards the mouthpiece 10, and a second branching point 13, located downstream towards the delivery device 19. The first particle separating device 12 is connected or arranged in a flow branch 42 and the second particle separating device 14 is connected or arranged in a flow branch 44, and the two flow branches (or: partial flow paths) 42 and 44 run together at the branching points 11 and 13.

Provided at the upstream first branching point 11 is a switchover device 33, which in a first switching state connects the mouthpiece 10 to the delivery device 19 via the first flow branch 42 and thus via the first particle separating device 12 and in a second switching state connects the mouthpiece 10 to the delivery device 19 via the second flow branch 42 and thus via the second particle separating device 14. The switchover device 33 can thus switch back and forth between the two particle separating devices 12 and 14.

The switchover device 33 is controllable by the operator, in particular the dentist or a dental assistant, via an operating device 31 or is switchable between its two switching states. Without restricting generality, the operating device 31 may comprise a switch, in particular a pressure switch, rotary switch or slide switch, or else comprise some other input device, for example a keypad or a voice input. In particular, the operating device 31 may be coupled directly in a mechanical or magnetic manner to the switchover device 33 and switch the latter over mechanically. For example, a valve or a two-way or multi-way valve as switchover device 33 can be mechanically actuated via a pressure switch, rotary switch or slide switch. Alternatively, the operating device 31 can also be coupled to the switchover device 33 via an electrical connection and actuate an electric actuator or drive via an electrical signal or an electrical current, for example for an electromagnetic valve or an electrically driven two-way or multi-way valve as switchover device 33. Similarly, is it also possible to actuate the switchover device 33 via a pneumatic connection.

When the dentist is treating a patient, with the treatment involving amalgam being removed from one or more teeth, he or she will use the operating device 31 to switch the switchover device 33 into the first switching state and thus activate the first particle separating device 12 for separating the particles that contain amalgam from the suction-extraction material A. In the meantime, the second particle separating device 14 remains deactivated and can therefore also not be contaminated with amalgam.

When the dentist is treating a patient, with the treatment involving gold fillings or other tooth material that contains noble metal needing to be removed from the teeth, he or she will first of all use the operating device 31 to switch the switchover device 33 into the second switching state and thus activate the second particle separating device 14, in which substantially all the particles that contain noble metal are separated from the suction-extraction material A. The first particle separating device 12 remains deactivated in this case, so that no particles that contain noble metal pass into it.

In the embodiment according to FIG. 2, the two particle separating devices 12 and 14 are now connected in series in terms of flow between the mouthpiece 10 and the delivery device 19, specifically, as seen in the flow direction, with the second particle separating device 14 upstream of the first particle separating device 12. The second particle separating device 14 is located in a flow branch 64 between two branching points 15 and 17. A bypass branch or bypass connected in parallel with the flow branch 64 is designated 54.

Provided at the upstream branching point 15 is a switchover device 34, which is actuable via an operating device 31 and in a first switching state directs the suction-extraction material A flowing past from the mouthpiece 10 exclusively into the bypass branch 54, so that the second particle separating device 14 is bypassed, and in the second switching state directs the suction-extraction material A exclusively into the branch 64 and thus allows it to flow through the second particle separating device 14. In this embodiment, the suction-extraction material A flows in both switching states via the branching point 17 through the first particle separating device 12.

In the embodiment according to FIG. 2, the dentist, when milling out or drilling out amalgam, uses the operating device 31 to switch the switchover device 34 into the first switching state and thus deactivate the second particle separating device 14, so that only the first particle separating device 12 is operative and the suction-extraction material A flows only through the first particle separating device 12, but not through the second particle separating device 14. In the first particle separating device 12, the suction-extraction material A is freed of the amalgam particles.

However, when the dentist is removing gold or other tooth materials that contain noble metal from the teeth, he or she will first of all use the operating device 31 to switch the switchover device 34 into the second switching state and thus connect the second particle separating device 14 into the flow path of the suction-extraction material A, in which substantially all of the particles containing noble metal are separated from the suction-extraction material A. The first particle separating device 12 connected downstream is now not operative, at least with regard to particles that contain noble metal.

Even though the order of the particle separating devices 12 and 14 according to FIG. 2 is preferred, it would nevertheless also be possible to connect the second particle separating device 14 provided for particles that contain noble metal downstream of the first particle separating device 12 and to provide the bypass at the first particle separating device 12, that is to say simply to exchange the particle separating devices 12 and 14 in FIG. 2. In order to separate particles that contain noble metal, the first particle separating device 12 would then be bypassed and, in order to separate particles that do not contain noble metal and/or contain mercury, the suction-extraction material A would first of all be guided via the first particle separating device 12, since or if the latter reliably removes the particles.

In FIG. 3, a branching device 22 is connected downstream of the mouthpiece 10. The branching device 22 comprises an inlet 24, a first outlet 26 and a second outlet 28. The branching device 22 is switchable between the first outlet 26 and the second outlet 28, so that a connection exists either between the inlet 24 and the first outlet 26 or between the inlet 24 and the second outlet 28.

The first outlet 26 is coupled to the inlet of the first particle separating device 12. The second outlet 28 is coupled to the inlet of the second particle separating device 14.

Connected downstream of the first particle separating device 12 is a first delivery device 16. Connected downstream of the second particle separating device 14 is a second delivery device 18. The delivery devices 16 and 18 are provided to generate a negative pressure in the mouthpiece 10 and the respectively associated particle separating devices 12 and 14 so that a sucking effect is produced.

The outlets of the delivery devices 16 and 18 are connected to a wastewater system, if it is a wet suction unit. In this case, further filter devices may be connected downstream of the delivery devices 16 and 18. In an alternative embodiment, instead of the two delivery devices 16 and 18, a single delivery device can again be provided, said single delivery device being connected downstream of the two particle separating devices 12 and 14.

In this example according to FIG. 3, there is provided a control device 30 for controlling and/or regulating the delivery devices 16 and 18 and the particle separating devices 12 and 14. In alternative embodiments, it may be sufficient for the control device 30 to be provided for controlling and/or regulating either the delivery devices 16 and 18 or the particle separating devices 12 and 14.

By means of the switchable branching device 22, which is thus a switchover device, either the first particle separating device 12 for separating particles that contain amalgam or the second particle separating device 14 for separating particles made of noble metals and/or noble metal compounds can be activated. The branching device 22 is manually switchable by the dentist or some other operator. Depending on whether an amalgam filling or a tooth replacement made of noble metal is currently being treated, one of the two particle separating devices 12 and 14 can be activated, so that the particles containing amalgam and the particles made of noble metal are collected in different particle separating devices 12 and 14.

The particle separating devices 12 and 14 can be designed such that those particles that differ considerably in terms of density and grain size from the particles that contain amalgam or noble metal are let through by the particle separating devices 12 and 14. In this way, the particle separating devices 12 and 14 can be provided with low outlay in terms of structural design and so the suction arrangement according to the invention can be produced in a cost-effective manner.

In the embodiment according to FIG. 4, the suction arrangement has a further mouthpiece 20 in addition to the first mouthpiece 10. No branching device or switchover device is now provided, in contrast to the embodiments according to FIGS. 1 to 3.

The first particle separating device 12 is connected downstream of the mouthpiece 10. The second particle separating device 14 is connected downstream of the further mouthpiece 20. Furthermore, the first delivery device 16 is connected downstream of the first particle separating device 12 and the second delivery device 18 is connected downstream of the second particle separating device 14. The delivery devices 16 and 18 are again provided to generate the negative pressure in the mouthpieces 10 and 20, respectively, and in the particle separating devices 12 and 14, respectively, so that a sucking effect is produced, and pump the suction-extraction material A′ that is cleaned or freed of the particles into the wastewater system again.

According to FIG. 4, too, the control device 30 for controlling and/or regulating the delivery devices 16 and 18 of the particle separating devices 12 and 14 is provided. In alternative embodiments, it may be sufficient for the control device 30 to be provided for controlling and/or regulating either the delivery devices 16 and 18 or the particle separating devices 12 and 14.

In the suction arrangement according to FIG. 4, sorting of the particles that contain amalgam from the particles that contain noble metal takes place with the aid of the selection and definition of the mouthpiece 10 or 20. Automatic separation of the particles that contain amalgam from the particles made of noble metal is not necessary in this embodiment, too.

The suction arrangement according to FIG. 5 differs from the embodiment according to FIG. 4 in that a further control device 32 is provided in addition to the control device 30. The control device 30 is provided to control and/or regulate the first particle separating device 12 and the first delivery device 16. The further control device 32 is provided to control and/or regulate the second particle separating device 14 and the second delivery device 18. In alternative embodiments, it may be sufficient for each control device 30 and 32 to be provided for controlling and/or regulating either the delivery device 16 or 18 or the particle separating device 12 or 14.

According to FIG. 6, two particle separating devices 12 and 14 that are connected in parallel are connected downstream in each case of an associated suction mouthpiece 10 and 20 and are connected downstream to a common delivery device 19 via a common connecting point 27. By using the mouthpiece 10, in a manner similar to in FIGS. 4 and 5 but with only one delivery device 19, the dentist can extract by suction amalgam that is separated in the particle separating device 12, and by using the mouthpiece 20, the dentist can extract by suction noble metal that is separated in the particle separating device 14.

In the embodiment according to FIG. 7, two separate suction mouthpieces 10 and 20 are again provided, as in FIG. 6, but in contrast to FIG. 6, in this case the first particle separating device 12 is arranged downstream of the branching point 27, and so is not connected, as in FIG. 6, downstream of only the first mouthpiece 10, but of both mouthpieces 10 and 20, while the second particle separating device 14 is connected downstream of only the second mouthpiece 20.

The suction arrangement according to FIG. 8 comprises again two particle separating devices 12 and 14 that are connected in series, of which, however, the second particle separating device 14 is now connected upstream of the first particle separating device 12 and can be added or coupled in manually or mechanically and can likewise be removed mechanically or manually, in order to produce a direct connection between the mouthpiece 10 and the first particle separating device 12 when the second particle separating device 14 is removed. Furthermore, the second particle separating device 14, when it is full, can be exchanged for or replaced by a new second particle separating device. Here, by manually coupling in or interposing the second particle separating device 14 or by uncoupling or removing it, the dentist can directly sort according to particles that contain noble metal and are free of mercury or particles that contain mercury. However, instead of a manually exchangeable configuration, it is also possible to provide an automatic removal and fitting mechanism for the second particle separating device 14, said mechanism comprising for example a drive and an actuating element for the dentist.

FIG. 9 shows a preferred embodiment of a suction arrangement having a second particle separating device integrated in an adapter or connection piece 25 for the mouthpiece 10. The connection piece 25 connects the mouthpiece 10, or a tube connection stub located thereon, in a manner known per se to a delivery tube 53, in particular by way of a plug-in or rotary connection or other coupling. According to FIG. 9, a holding device (not illustrated in more detail) for the second particle separating device 14 is provided in the connection piece 25, the second particle separating device 14 being held in said holding device so that it is located in the flow path of the oral fluid A. If sufficient noble metal particles have been sucked in by the mouthpiece 10 and have been collected in the second particle separating device 14, the connection piece 25 as a whole or else only the second particle separating device 14 is taken out and supplied for recycling. The second particle separating device 14 is in this case preferably a filter device, since such a device can be configured in a compact manner.

Finally, as an alternative or in addition to the previous embodiment, a second particle separating device 14 can also be arranged in the region of or in front of the suction opening of the mouthpiece 10 (or 20), it then being possible for said second particle separating device 14 to be either connected upstream of the mouthpiece 10, externally in the flow path of the oral fluid A, and to be structurally separated from the mouthpiece, or to be structurally integrated or fastened or fastenable on or in the mouthpiece 10.

FIG. 10 shows an exemplary embodiment having a second particle separating device 14 which is arranged in an exchangeable manner at the suction opening of the mouthpiece 10, is configured for example itself in a manner widening in the form of a funnel or is held in a funnel-shaped holding device, but can also have some other shape. Here, the noble metal particles are separated as early as during suction, before or when the oral fluid A enters the mouthpiece 10, and they can be recovered after the second particle separating device 14 is removed from the mouthpiece 10.

A second particle separating device 14 can also be insertable or introducible into the mouth of the patient separately from the mouthpiece 10. In these embodiments, in order to remove the noble metal particles, the second particle separating device 14 can either first be removed from the mouth or be extracted by suction by the mouthpiece 10 while still in the mouth, it then being possible for the noble metal particles to be separated out from the suction-extraction material by a further second particle separating device 14, as for example in FIGS. 1 to 9.

The second particle separating device 14 can furthermore be configured in particular in the form of a filter device having a filter that consists of a woven or knitted fabric of suitable mesh width or else in the form of a particle collecting carrier having a suitable, for example adhesive, surface, to which the particles adhere. A modified protective or separating or damming device, such as what is known as a cofferdam, which is arranged or arrangeable around at least one tooth can serve as such a carrier, in the case of which the surface is formed in an appropriate manner to collect the particles. Furthermore, cotton rolls or the like or a glove or a felt finger covering, by way of which the noble metal dust is removed from the mouth, would be suitable.

Furthermore, one or more screens, filter devices and/or further particle separating devices may be connected upstream and/or downstream of the particle separating devices 12 and 14. These screens, filter devices or further particle separating devices are provided in particular for those particles which differ sufficiently in terms of density and grain size from the particles that contain amalgam and noble metal.

Furthermore, instead of or in addition to the suction mouthpiece, the suction arrangement may also comprise a collecting basin (or: cuspidor, sink) in order to collect (spat-out) oral fluid, which is then again extracted by suction via the delivery device(s), as a rule with further rinsing fluid. In the case of this oral fluid which is initially spat out and then extracted by suction, the described particle separation can be configured or carried out in the same way as in the case of the oral fluid extracted directly from the mouth by suction. The delivery device for generating the negative pressure is then connected at the drain of the collecting basin.

### REFERENCE NUMERALS

10 Suction mouthpiece
11 Branching point
12 First particle separating device
13 Branching point
14 Second particle separating device
15 Branching point
16 First delivery device
17 Branching point
18 Second delivery device
19 Delivery device
20 Suction mouthpiece
21 Tube
22 Branching device
23 Tube
24 Inlet
25 Adapter
26 First outlet
28 Second outlet
30 Control device
31 Operating device
32 Control device
33, 34 Switchover device
42, 44 Flow branch
53 Delivery tube
54 Bypass branch
64 Flow branch
A, A′ Suction-extraction material

1-31. (canceled)

32. A suction arrangement for dental treatments for the suction-extraction of oral fluid originating from the mouth of a patient, comprising:
a) at least one suction mouthpiece, which is introduced or introducible into the mouth of the patient in order to extract the oral fluid from the mouth by suction; and/or
b) at least one delivery device, which is connected or connectable via at least one flow path to at least one suction mouthpiece in order to generate a negative pressure at the suction mouthpiece and in order to extract the oral fluid by suction; and
c) at least one collecting arrangement for collecting particles from the oral fluid extracted by suction, the collecting arrangement having:
c1) a first particle separating device for separating particles from the oral fluid, wherein the first particle separating device is arranged or arrangeable in a flow path of the oral fluid;
c2) a second particle separating device for separating particles from the oral fluid, wherein the second particle separating device is arranged or arrangeable in a flow path of the oral fluid;
wherein:
c3) the first particle separating device is activated or operative when particles that do not contain noble metal and/or contain mercury are present in the oral fluid;
c4) the second particle separating device is active or operative when particles that contain noble metal are present in the oral fluid and is deactivated or inoperative when particles that do not contain noble metal and/or contain mercury are present in the oral fluid; and
c5) the second particle separating device is arranged or arrangeable in the mouth of the patient in front of the suction opening of the suction mouthpiece, or in the suction mouthpiece itself, or in a connection part for the suction mouthpiece.

33. A suction arrangement as claimed in claim 32, further comprising a switchover device, wherein:
in a first switching state, the switchover device switches the second particle separating device into the flow path of the oral fluid or arranges it therein; and
in a second switching state, the switchover device switches the second particle separating device out of the flow path of the oral fluid or removes it therefrom.

34. The suction arrangement as claimed in claim 33, further comprising an operating device, which is connected or connectable to the switchover device, for actuating or switching the switchover device.

35. The suction arrangement as claimed in claim 34, in which the operating device comprises at least one switch, in particular a pressure switch, rotary switch or slide switch, or else some other input device, for example a keypad or a voice input.

36. The suction arrangement as claimed in claim 34, wherein the operating device:
is mechanically or magnetically coupled to the switchover device; and
mechanically switches or actuates the switchover device.

37. The suction arrangement as claimed in claim 34, wherein the operating device is:
electrically coupled to the switchover device; and
electrically switches or actuates the latter.

38. The suction arrangement as claimed in claim 33, wherein the switchover device comprises a valve or a two-way or multi-way valve.

39. The suction arrangement as claimed in claimed in claim 33, wherein the switchover device comprises:
an electric actuator or drive; and/or
an electromagnetic valve; or
an electrically driven two-way or multi-way valve.

40. The suction arrangement as claimed in claim 33, further comprising at least one sensor unit, which is connected or connectable to the switchover device, for actuating or switching the switchover device in order to sense the presence of noble metal or mercury in the oral fluid.

41. The suction arrangement as claimed in claim 32, wherein:
in a first switching state of the switchover device, the first particle separating device is located acting in a separating manner in the flow path in order to separate particles that do not contain noble metal and/or contain mercury from the oral fluid; and
in the second switching state of the switchover device, the second particle separating device is located acting in a separating manner in the flow of oral fluid in order to separate particles that contain noble metal and do not contain mercury from the oral fluid.

42. The suction arrangement as claimed in claim 41, wherein the second particle separating device is connected upstream of or in front of the first particle separating device in the flow direction.

43. The suction arrangement as claimed in claim 32, wherein the second particle separating device is arranged or arrangeable in the mouth of the patient, in particular in the vicinity of the tooth being treated, and/or in front of or at the suction opening of a suction mouthpiece or in the suction mouthpiece itself.

44. The suction arrangement as claimed in claim 32, wherein the first particle separating device and/or the second particle separating device comprises at least one filter device, which comprises in particular at least one woven filter fabric or knitted filter fabric, and/or at least one separation device, in particular a gravity separation device or centrifugal separation device, and/or at least one carrier, in particular a cofferdam, having a surface to which the particles adhere.

45. The suction arrangement as claimed in claim 32, wherein the second particle separating device:
is exchangeable manually or automatically, in particular by means of a drive; or
is insertable or introducible into the flow path of the oral fluid and also removable therefrom again.

46. The suction arrangement as claimed in claim 45, further comprising:
a holding device for holding the second particle separating device in the flow path of the oral fluid;
wherein:
in particular when particles that contain noble metal are present in the oral fluid, the second particle separating device is inserted or introduced into the holding device or a component formed from the second particle separating device together with the holding device is inserted or introduced into the flow path of the oral fluid; and
when particles that do not contain noble metal and/or contain mercury are present in the oral fluid, the second particle separating device is removed from the holding device or the component formed from the second particle separating device and the holding device is removed from the flow path of the oral fluid.

47. The suction arrangement as claimed in claim 32, wherein the first particle separating device and/or the second particle separating device are or is arranged or arrangeable between at least one suction mouthpiece and at least one delivery device.

48. A suction arrangement as claimed in claim 32, having
a) at least two suction mouthpieces, at least one of which is inserted or insertable into the mouth of the patient in order to extract oral fluid from the mouth by suction,
e) wherein the first particle separating device is connected downstream at least of the first suction mouthpiece and the second particle separating device is connected downstream of the second suction mouthpiece but not of the first suction mouthpiece.

49. The suction arrangement as claimed in claim 46, wherein:
the holding device for the second particle separating device is configured as the holding device for the second particle separating device itself or a component formed from the holding device; and
the second particle separating device is configured as, with or on a connection part, via which the suction mouthpiece is connected or connectable, in particular in a detachable manner, to a delivery line or a delivery tube.

50. A method using the suction arrangement as claimed in claim 32 for sucking or extracting oral fluid originating from the mouth of a patient during a dental treatment, comprising:
a) introducing at least one suction mouthpiece into the mouth of the patient; and/or
b) providing at least one collecting basin for collecting oral fluid;
wherein:
c) at least one delivery device, which is connected or connectable via at least one flow path to at least one suction mouthpiece or the collecting basin, generates a negative pressure at the suction mouthpiece and/or collecting basin in order to extract the oral fluid by suction;
d) a first particle separating device, which is arranged or arrangeable in the flow path of the oral fluid, in particular in the flow path between at least one suction mouthpiece or the collecting basin and at least one delivery device, is activated or is switched into the operative state when the oral fluid contains particles that contain mercury, and which thus separates the particles that contain mercury from the oral fluid;
e) a second particle separating device, which is arranged in the flow path between at least one suction mouthpiece and at least one delivery device, is activated or switched into the operative state, or a second particle separating device is arranged in or introduced into the flow path of the oral fluid, in particular into the flow path between at least one suction mouthpiece or the collecting basin and at least one delivery device, when the oral fluid contains particles that contain noble metal, and thus the second particle separating device separates the particles that contain noble metal from the oral fluid, and
f) the second particle separating device, which is arranged in the flow path, is deactivated or switched into the inoperative state, or the second particle separating device is removed from the flow path, when the oral fluid contains particles that contain mercury.
